(19) United States
(12) Patent Application Publication
(10) Pub. No.: US 2015/0232012 A1
(43) Pub. Date: Aug. 20, 2015

(54) CAM BUCKLE ASSEMBLY WITH IN-LINE ELASTIC MEMBER

(71) Applicant: Douglas Wright, Piedmont, SC (US)

(72) Inventor: Douglas Wright, Piedmont, SC (US)

(21) Appl. No.: 14/181,957

(22) Filed: Feb. 17, 2014

(51) Int. Cl. B60P 7/08; A44B 11/06; A44B 11/00

(52) U.S. Cl. CPC B60P 7/0823; A44B 11/005; A44B 11/06

(57) ABSTRACT

A cam buckle assembly for cargo and other items that responds elastically to the forces acting on the cam buckle assembly thereby preventing the tied-down item from escaping its restraints. The cam buckle assembly does not over-stress the item being tied-down by providing an adjustable elastic member that can be adapted to the tie-down requirements of the cargo.

### CROSS-REFERENCE TO RELATED APPLICATIONS

### Background of the Invention

This invention relates to a cam buckle device, specifically to cam buckle devices such as for example straps or the like that have hooking connections at opposite ends which in many cases can be adjusted lengthwise, but are not generally elastic. The cam buckle device of this invention corrects a problem in the transport of small items.

Cam buckles of the generally non-elastic type do not include any means for self-compensating the length of the cam buckle mechanism. Specifically, when transporting items, current cam buckles, even though pulled taut, can develop a slack in the cam buckle because the item can move vertically downward relative to its carrier thus loosening the straps.

A need therefore exists in the art for dealing with the types of problems mentioned above. Using the particular example of hauling small items, the need exists for a cam buckle device where the transported item will continue to be securely tied-down even over uneven transport and without using undue force on the cam buckle and without damaging the integrity of the item.

Similar problems with respect to other uses of non-elastic cam buckles exist. For example, securing any object with such cam buckles involves tightening them as much as possible without damage to the item, the cam buckle or whatever it is tied to. Slack, even small, can develop, especially with respect to forces that can be generated on bumpy roads or terrain. The need therefore exists for an improved cam buckle that can be advantageously applied to a variety of uses for cam buckles.

Accordingly besides the objects mentioned above, advantages of the present invention are; to provide a cam buckle for cargo and other items that responds elastically to the forces acting on the cam buckle assembly thereby preventing the tied-down item from escaping its restraints, and to provide a cam buckle for cargo and other items that does not over-stress the item being tied-down, and to provide an adjustable elastic member for the cam buckle assembly that can be adapted to the tie-down requirements of the cargo.

### BRIEF SUMMARY OF THE INVENTION

In accordance with one aspect of the present invention, the foregoing and other objects are achieved by a generally inelastic cam buckle device that incorporates an elastic member in-line with the tie-down forces that can be adjusted for various modulus' of elasticity, and is used to hold items in place when movement or shifting of the tied-down item or other forces would cause a non-elastic cam buckle device to loosen and thereby possibly fail to perform in certain applications of transport.

The elastic member is secured in-line with tension forces of the generally inelastic cam buckle device in such a manner that when the elastic member is in its normal or relaxed position a certain amount of slack is allowed in that portion of the generally inelastic cam buckle device between points where the elastic member is attached thereto. When the cam buckle device is made taut during a cam buckle application, the elastic member is then stretched. In one embodiment, the modulus of elasticity of the elastic member can be adjusted for varying load requirements. Any slackening of the cam buckle during the application would then be compensated for by the elastic member forcing the slack to be taken up without a loosening of the entire cam buckle assembly.

### BRIEF DESCRIPTION OF THE DRAWINGS

FIG. 1 is perspective view of the cam buckle with elastic member used for strapping down items being transported.

FIG. 2 shows the cam buckle having a standard helical spring elastic member connected to an S-hook with a keeper.

FIG. 3 shows the standard helical spring elastic member.

FIG. 4 shows the adjustable helical spring elastic member embodiment.

### DETAILED DESCRIPTION OF THE INVENTION

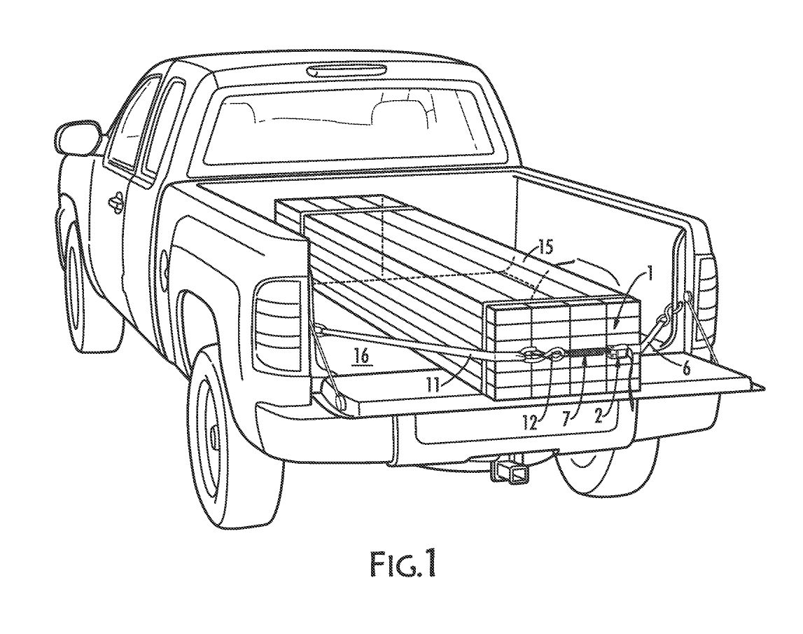

The cam buckle assembly for transportation items according to an embodiment of the present invention, is illustrated in FIG. 1. The cam buckle assembly 1 provides the mechanism for holding items 15 to the transport carrier 16 (e.g. small pickup trucks or motorcycle). It is to be understood that sometimes one assembly would be sufficient to secure the item 15 but multiple assemblies may be required depending on the geometry and weight of the transported item. 15.

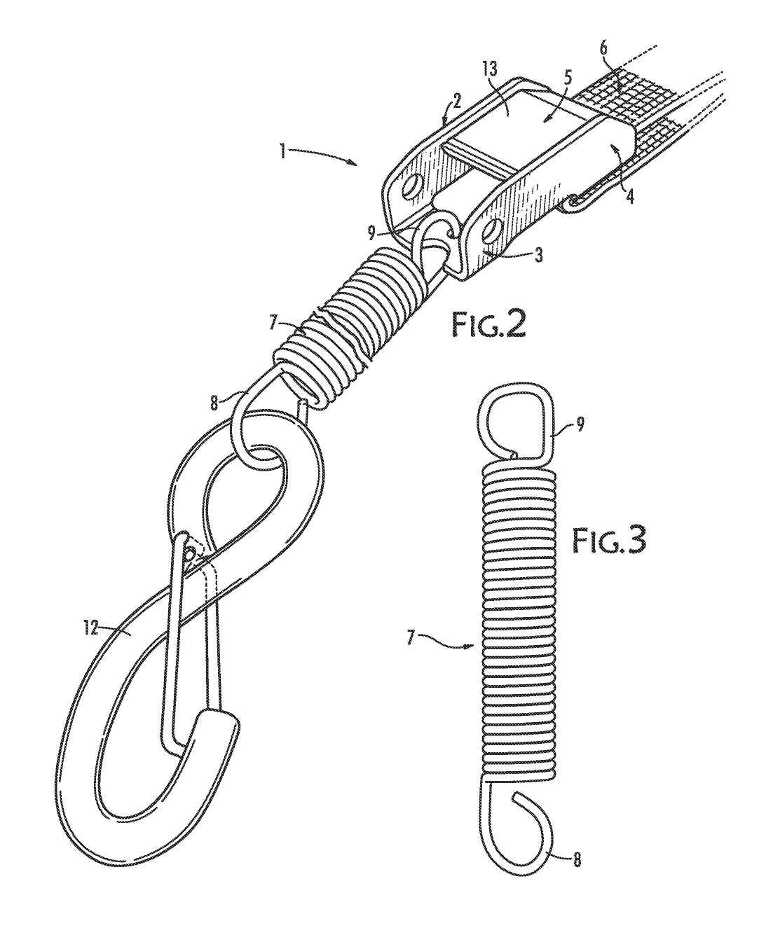

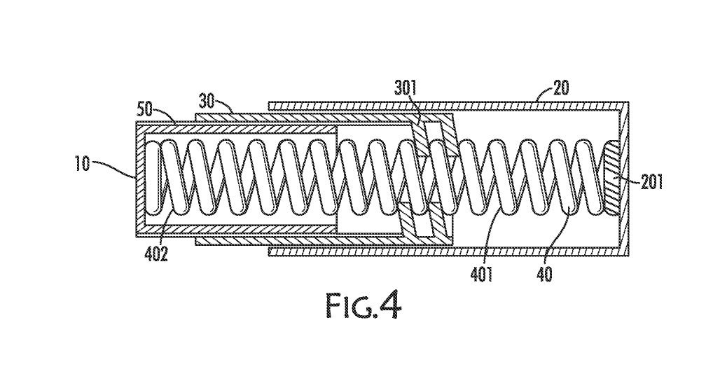

FIGS. 1, 2 and 3 show the cam buckle assembly 1 having a cam buckle 2 with a proximal portion 3 and a distal portion 4. The distal portion 4 has a releasable means for securing 5 a distal strap 6 to the distal portion 4. An elastic member 7 has a proximal end 8 and a distal end 9. The distal end 9 is removably disposed on the proximal portion 3 of the cam buckle 2. A means for hooking 12 a proximal strap 11 to the proximal end 8 of the elastic member 7 can be at least one device selected from the group consisting of S-hook, keeper S-hook, and interlocking clamps. The releasable means for securing 5 further comprises a cam (not shown) and a hinged compression plate 13 for securing the distal strap 6 against the cam.

The elastic member 7 provides elasticity and self-tensioning in the assembly and is least one member selected from the group consisting of extension spring, torsion spring, helical spring, adjustable helical spring, gas spring, shock absorber, and strut. One embodiment of the elastic member 7 is an adjustable helical spring as shown in FIG. 4. And taught in U.S. Pat. No. 6,676,118, incorporated herein by reference. An adjustable casing for helical spring mainly includes a male case 10, a female case 20, and a rotation member 30. The female case 20 is provided at an inner bottom center with a fixing seat 201. The rotation member 30 is a hollow sleeve member movably located between the male and the female cases 10, 20, and is provided around an inner surface at predetermined positions with a plurality of stoppers 301. The male case 10 has an outer diameter slightly smaller than an inner diameter of the rotation member 30, and the rotation member 30 has an outer diameter slightly smaller than an inner diameter of the female case 20. A pair of screw threads 50 are correspondingly formed on an outer surface of the male case 10 and the inner surface of the rotation member 30 in contact with each other, so that the male case 10 and the rotation member 30 are rotatably connected to each other. A helical spring 40 is enclosed in a spring chamber 402 defined between the male case 10 and the stoppers 301 of the rotation member 30. An end of the helical spring 40 is fixedly connected to the fixing seat 201 in the female case 20 and another end of the helical spring 40 is located in the male case 10, such that some coils 401 of the helical spring 40 fitly engage with the stoppers 301 in the rotation member 30. When the helical spring 40 is subject to a stretching or a compressing force, the female case 20 does not frictionally contact with the rotation member 30. When the rotation member 30 is rotated along the screw threads 50, the stoppers 301 in the rotation member 30 remain in contact with and are guided by the coils 401 to move along the helical spring 40, and thereby change the number of active coils 401 of the helical spring 40 between the stoppers 301 and the bottom of the female case 20, that is, the number of active coils 401 that would be subject to a compressing or a stretching force. Each of the screw threads 50 has a screw pitch that is equal to a coil pitch of the coils 401. Therefore, when the rotation member 30 is rotated by one full circle, it moves along the helical spring 40 by one coil pitch of thereof and thereby changes the number of active coils 401 by one. At this point, the modulus of elasticity of the helical spring 40 is changed. This rotation member 30 adjustment enables the entire cam buckle assembly 1 to be ‘tuned’ to the cargo load specifications thereby preventing damage and shifting. The adjustment prevents the elastic member 7 from exceeding the tensile strength of the remainder of the tie-down including the cam buckle 2, distal strap 6, proximal strap 11 and means for hooking 12. and 11.

In the extended state, elastic member 7 would attempt to return to its original position. It would be precluded from doing so because its resilient force has been overcome by pulling the cam buckle taut. However, if any slack would be experienced anywhere along distal strap 6 of proximal strap 11 (by shifting of the object or forces experienced while travelling), elastic member 7 would resiliently stretch to take up as much of that slack as is possible.

A specific example of operation and the manner of using the cam buckle assembly for transportable items, according to an embodiment of the present invention, is set forth below. Its normal use is identical to that for cam buckle devices in present use. Namely, one can secure the objects to its transport carrier 16 by attaching a cam buckle assembly 1 as illustrated in FIG. 1. Hooks are used for attaching the distal strap 6 and proximal strap 11 to the transport carrier 16. After the hooks are attached to the transport carrier and the cam buckle assembly is positioned in a slack condition to the object being tied-down, any slack or looseness of the inelastic cam buckle strap is pulled taut through the cam buckle 2. This action puts the elastic member 7 of the cam buckle assembly 1 under tension. The cinching of the distal strap 6 through the cam buckle 2 stretches the elastic member 7 to which it is attached. The elastic member 7 is elongated so as to compensate for any slack in the inelastic member that can develop when the transport carrying the cargo, for example, encounters rough terrain sufficient to cause the inelastic member to go slack.

It is to be understood that the elastic member added for the purpose of ensuring the proper function of cam buckles under these types of conditions is selected to have properties that allow the inelastic member to be pulled taut without exceeding the elastic limit or resiliency of the elastic member. Accordingly, the cam buckle assembly for transportable items will prevent or deter potentially harmful slackening when items are being transported over certain terrains or when other forces come into play.

Although the description above is primarily in reference to transporting small items, the same principle of cam buckle has application more generally. The specific example should not be construed as limiting the scope of the invention but as merely providing an illustration of the presently preferred embodiment of this invention. Note also that in the preferred embodiment, the elastic member 7 is preferably placed as near to a hook 12 as possible, but could be placed anywhere along strap. Also, it can be of a variety of different lengths, depending on the size and application of the cam buckle. For example, elastic member 7 could be several inches long or many inches long.

While there has been shown and described what are at present considered the preferred embodiments of the invention, it will be obvious to those skilled in the art that various changes and modifications can be made therein without departing from the scope.

1. A cam buckle assembly comprising;
a cam buckle having proximal and distal portions wherein said distal portion further comprises a releasable means for securing a distal strap to the distal portion,
an elastic member having proximal and distal ends wherein the distal end is removably disposed on the proximal portion of the cam buckle, and
a means for hooking a proximal strap to the proximal end of the elastic member.

2. The cam buckle assembly of claim 1 wherein said elastic member further comprises at least one member selected from the group consisting of extension spring, torsion spring, helical spring, adjustable helical spring, gas spring, shock absorber, and strut.

3. The cam buckle assembly of claim 1 wherein said releasable means for securing further comprises a cam and a hinged compression plate for securing the distal strap against the cam.

4. The cam buckle assembly of claim 1 wherein said means for hooking further comprises at least one device selected from the group consisting of S-hook, keeper S-hook, and interlocking clamps.
